(19) United States
(12) Patent Application Publication
(10) Pub. No.: US 2004/0198471 A1
(43) Pub. Date: Oct. 7, 2004

(54) Terminal output generated according to a predetermined mnemonic code

(76) Inventor: Douglas Deeds, Fort Worth, TX (US)

Correspondence Address: STEVEN A. SHAW, NOKIA, INC., 6000 CONNECTION DRIVE, MD 1-4-755, IRVING, TX, 75039, US

(21) Appl. No.: 10/131,989

(22) Filed: Apr. 25, 2002

(51) Int. Cl. H04B 1/00

(52) U.S. Cl. 455/575.1; 455/567; 455/415

(57) ABSTRACT

A communications system includes a communications network and a code generator. The communications network includes at least one terminal for communication. Each terminal includes a transmitter and a receiver for transmitting and receiving speech, respectively, and an output reproduction device capable of generating a detectable output in response to an event, such as an incoming call. The detectable output is generated based upon a coded representation of at least one character that has been converted in accordance with a predefined mnemonic code, such as Morse Code. The character(s) may form a predefined text message or be information regarding an incoming call. The code generator is in communication with the communications network and, as such, the code generator can receive at least one character and thereafter convert the character(s) into the coded representation according to the predetermined code.

### BACKGROUND

The present invention relates generally to terminals such as mobile telephones and, more particularly, relates to generating an output from a terminal in response to a predetermined event, where the output is generated according to a predetermined mnemonic code, such as Morse Code.

Conventional terminals, such as mobile telephones also known as mobile stations, have a detectable output, such as ring tones, similar to ordinary telephones, which have mainly resembled the ringing of a clock. When a mobile phone of a specific make and model had one fixed ring tone, however, problematic situations occurred. In this regard, when two users in the same space have the same type of mobile phone and, thus, the same kind of ring tone, it can be confusing as to whose phone is actually ringing. This source of confusion has been ameliorated by making the ringing tone dependent on either the user's own telephone number or the telephone number of a caller. However, the ringing tones produced on the basis of two almost identical telephone numbers may sound so much alike, that it is difficult to distinguish one ringing tone from the other.

Further improvements to providing more distinguishable ringing tones have been made as mobile phones have become more advanced. Currently, mobile phones normally have several pre-stored ringing tones from which the user can select a preferred ringing tone. In addition to ordinary ringing tones, melodies from familiar pieces of music have been implemented as ringing tones from which a user may select. With the enormous increase in the use of mobile phones, it has turned out that even as many as ten different ringing tones in a mobile phone are sometimes not enough to prevent mobile phone users from being confused as to whom a ringing telephone belongs. In addition, it may be that the user does not like any of the pre-stored ring tones. This situation has been improved by enabling ring tones to be programmed by the user via the user interface of the telephone or other communication device. One technique has been presented in U.S. Pat. No. 4,866,766, where a user can input different kinds of parameters, which define a pulsed ring tone sequence having parameters such as frequency, pulse length, the number of pulses in a group, period between pulses, the number of pulse groups, etc. Another technique has been presented in Publication WO 92/03891, where a ring tone of a paging device can be programmed by switching on or illuminating specific pixels on a matrix display. The position of the pixels in the vertical direction corresponds to a specific pitch of a note (E, F, G, A, H, C, D). Another corresponding technique has been presented in a European patent application bearing Publication EP 684 591 A1, where it is possible to program, on a display of a paging device, a ring tone so that the pitch of a note is displayed on the display as a letter symbol (DO, RE, MI, FA, SO, LA, TI) and the duration of a note can be modified by concatenating a number of the same letter symbols. Yet another technique for programming a ring tone has been presented in Finnish Patent Application 960858, submitted on Feb. 23, 1996, wherein it is possible to program a ring tone as notes by inputting the notes graphically on a stave that is displayed on a display.

Although a number of ring tone programming techniques have been proposed, the programming of ring tones through a user interface has its disadvantages. A user has to take the time to input different kinds of parameters, characters or notes in different ways. In addition, in many of the examples presented above, the user must have a knowledge of music theory in order to produce a specific melody with his/her telephone.

To facilitate the programming of a ring tone, U.S. Pat. No. 4,868,561 describes a technique wherein an owner of a paging device can obtain a new ring tone for the paging device via wireless communication. This is accomplished by the owner of the paging device phoning a paging system operator and selecting a desired ring tone from a catalogue of preprogrammed ring tones. In this case, a paging system operator first prepares the paging device for the changing of the ring tone by sending the paging device a message notifying it of the changing of the ring tone. And after that, the paging system operator sends a ring tone sequence wirelessly that is received by the paging device and stored in memory so as to replace the prior ring tone sequence.

A disadvantage of this technique, however, is that a user must contact a paging system operator and is limited to those ring tones provided by the paging system operator. While a ring tone sequence is downloaded, the paging device also cannot simultaneously receive a paging message because the transmission of a ring tone sequence keeps the channel engaged at that moment.

Another methodology for programming a ring tone has been presented in U.S. Pat. No. 6,094,587 entitled: Programming of a Telephone's Ringing Tone, issued Jul. 25, 2000 to Armanto et al. According to the '587 patent, the ring tone is sent to a mobile station in the form of a ring-tone message including an identifier identifying the message as a ring tone. Upon reception, the ring-tone message is identified based upon the ring tone identifier and thereafter modified into a suitable form for a ring-tone generator and for storage. The ring tone may be sent as characters in a short message such as Short Message Service (SMS), Unstructured Supplementary Service Data (USSD) or by means of the infrared transceiver or other means of local data transfer.

In accordance with another technique, the ring tone can be sent to the mobile station via a wireless application protocol (WAP) browser included within the mobile station. Before receiving the ring tone, however, the ring tone is requested from the mobile station by sending a message with a header comprising an identification number to a ring tone or media server. In response, then, the mobile station receives a message that includes the ring tone. Thereafter, the ring tone can be saved into memory for subsequent use by the mobile station.

Although reliable techniques have been provided for programming a ring tone, it is always desirable to further improve upon the methods of programming and generating a ring tone. In this regard, it would be desirable to design a system, mobile station and method of generating a detectable output, such as a ring tone, from a mobile station that allows a user of the mobile station to uniquely associate any number of events, such as incoming telephone calls, short messages or the like, with different ring tones without being constrained to a small number of pre-stored ring tones. Further, it would be desirable for the ring tone of the mobile station to spell out a text message or provide other information regarding an incoming call in a predefined code so that the ring tone is not only associated with a respective event, but also identifies the respective event. By spelling out the text message or information regarding an incoming call, not only can the ring tone identify an event, but the ring tone can additionally distinguish the mobile phone that is ringing in situations in which two users in the same space have the same type of mobile phone.

### SUMMARY

In light of the foregoing background, embodiments of the present invention provides an improved system, terminal and method of generating a detectable output, such as a ring tone or the like, in response to a predefined event, such as an incoming telephone call. According to the present invention, at least one character may be converted into a coded representation according to a mnemonic code, such as Morse Code; with the detectable output generated based upon the coded representation. For example, the character(s) may be text entered by a user or information, such as caller identification information, relating to an incoming telephone call. As such, a wide variety of detectable outputs, including a great variety of ring tones, may be generated, thereby facilitating user identification of the terminal that is receiving a telephone call or other event. Moreover, the detectable output may actually provide the user with some useful information such as the identity of a calling party in some embodiments. As such, the system, terminal and method in accordance with an embodiment of the present invention solve the problems identified by prior techniques and provide additional advantages.

According to one embodiment, a communications system includes a communications network and a code generator. The communications network comprises at least one terminal for communication. In turn, each terminal includes a transmitter and a receiver for transmitting and receiving speech, respectively, and an output reproduction device capable of generating a detectable output in response to an event, such as an incoming call. The output reproduction device can generate detectable output in a human perceptible form, such as audible sounds, mechanical vibration or light illumination.

Advantageously, the detectable output is generated based upon a coded representation of at least one character determined from converting the characters into the coded representation according to a predefined mnemonic code, as described below. As such, the detectable output can spell out a text message or provide information regarding an incoming call in a predefined mnemonic code so that the ring tone is not only associated with a respective event, but may also identify the respective event. By spelling out the text message or providing information regarding an incoming call, not only can the detectable output identify an event, but the detectable output can additionally distinguish a ring tone between two users in the same space having the same type of terminal.

The event may include an incoming call to the terminal. In this embodiment, each terminal further includes a controller in communication with the output reproduction device and the code generator. The controller is capable of determining information regarding the incoming call such that the information regarding the incoming call comprises the at least one character. And to further distinguish the ring tone generated in accordance with one embodiment of the present invention, the output reproduction device is capable of generating audible sounds based upon the coded representation of the character(s) with audible sounds associated with the coded representation of each character having at least one different predetermined pitch.

The code generator is in communication with the communications network including the mobile station(s). By being in communication with the terminal (s), the code generator can receive at least one character and thereafter convert the character(s) into the coded representation of the character(s) according to the predetermined mnemonic code, such as Morse Code. The code generator can be located in any manner relative to the terminal (s) but, in one embodiment, the code generator is located remote from the terminal (s). In this embodiment, the code generator can be in communication with the mobile communications network according to the wireless application protocol (WAP) standard. According to another aspect of the present invention, however, a terminal includes the code generator.

In operation, a method of generating a detectable output from a terminal adapted to transmit and receive speech begins by obtaining a text output including at least one character. The character(s) of the text output then are converted into the coded representation of the character(s) according to the predetermined mnemonic code, such as Morse Code. According to another embodiment, a method of generating a detectable output from a terminal begins by receiving an incoming call to the terminal and thereafter determining information regarding the incoming call that is comprised of at least one character. Next, the character(s) are converted into the coded representation of the character(s) according to the predetermined mnemonic code. In either embodiment, after converting the character(s), the detectable output is then generated in response to a predefined event based upon the coded representation of the character(s).

According to one embodiment, the detectable output is generated in a human perceptible form. According to certain aspects of the method, a detectable output parameter can be provided, where the detectable output parameter defines a pitch associated with the coded representation of at least some of the characters. As such, the coded representation of each character can be associated with at least one different predetermined pitch after converting the character(s).

The system, terminal and method of the present invention therefore uniquely associate any number of events with different detectable outputs without being constrained, such as to a small number of pre-stored ring tones. Further, the detectable output of the system, terminal and method of the present invention is capable of spelling out a text message in a predefined code to associate the detectable output with a respective event, as well as identify attributes associated with the respective event. As such, when the detectable output comprises a ring tone, the ring tone of the mobile station can be distinguished from the ring tone of similar mobile stations located nearby. Also, by generating the output based upon a coded representation of information regarding an incoming call, the system, terminal and method of the present invention can more precisely identify an incoming call, such as by a name associated with the calling party.

### BRIEF DESCRIPTION OF THE DRAWINGS

Having thus described the invention in general terms, reference will now be made to the accompanying drawings, which are not necessarily drawn to scale, and wherein:

FIG. 1A is a block diagram of a mobile communications system according to one embodiment of the present invention including a mobile station and a Base Station/MSC/lnterworking function (BMI) to which the mobile station is bidirectionally coupled through wireless RF links;

FIG. 1B is a block diagram of a mobile communications system according to another embodiment of the present invention including a mobile station and the Base Station/MSC/Interworking function (BMI), where the BMI is bidirectionally coupled to a wide area network;

FIG. 2 is a schematic diagram of a mobile station according to one embodiment of the present invention;

FIG. 3 is a chart illustrating various international characters and associated Morse code according to one embodiment of the present invention;

FIGS. 4A and 4B are timing diagrams for the word PARIS written in Morse Code according to standard timing and Farnsworth timing, respectively;

FIGS. 5A and 5B are flowcharts illustrating various steps in a method for programming a ring tone according to one embodiment of the present invention;

FIGS. 6A-6C are block diagrams highlighting the display of a mobile station at various stages in the method for programming a ring tone according to one aspect of the present invention; and

FIG. 7 is a flowchart illustrating various steps in a method for generating a ring tone from a mobile station according to one embodiment of the present invention.

### DETAILED DESCRIPTION

Embodiments of the present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

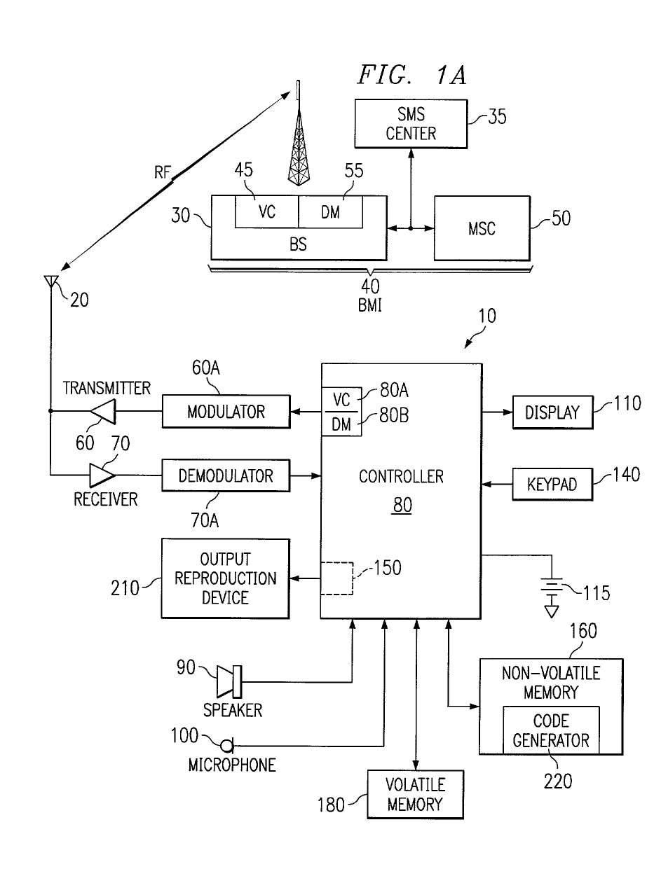

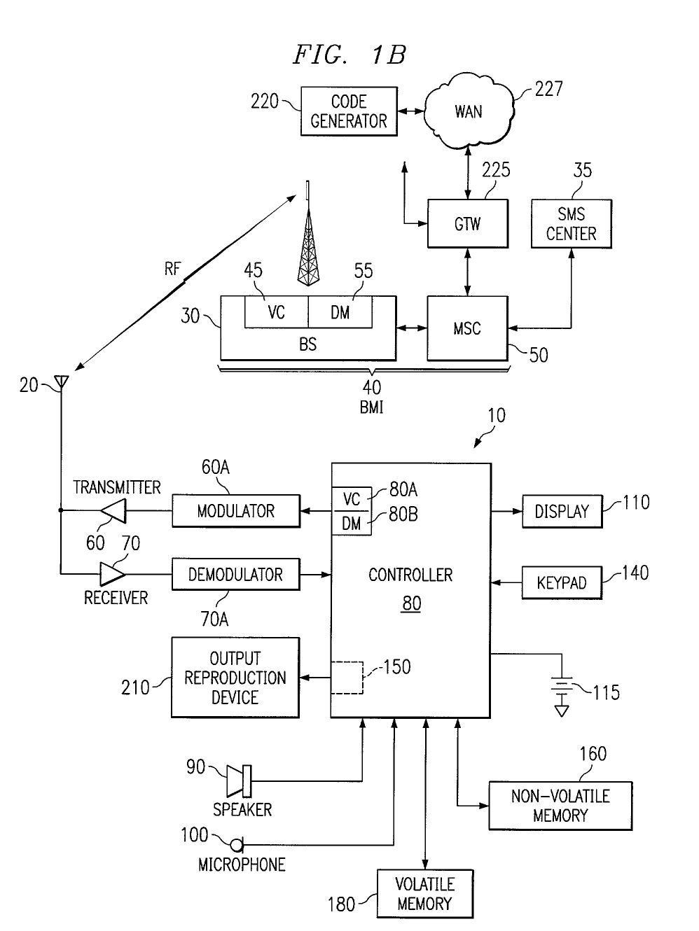

Referring to FIGS. 1 and 2, an illustration of one type of terminal, a mobile station, that would benefit from the present invention is provided. It should be understood, however, that the mobile telephone illustrated and hereinafter described is merely illustrative of one type of terminal that would benefit from the present invention and, therefore, should not be taken to limit the scope of the present invention. While several embodiments of the mobile station are illustrated and will be hereinafter described for purposes of example, other types of terminals, such as landline telephones, pagers and other types of voice and text communications systems, can readily employ the present invention. Moreover, the system, terminal and method of the present invention will be primarily described in conjunction with mobile communications applications. But the system, terminal and method of the present invention can be utilized in conjunction with a variety of other applications, both in the mobile communications industries and outside of the mobile communications industries.

As shown, the mobile station 10 includes an antenna 20 for transmitting signals to and for receiving signals from a base site or base station (BS) 30. The base station is a part of a cellular network that includes a mobile switching center (MSC) 50, an SMS center 35, voice coder/decoders (vocoders) (VC) 45, data modems (DM) 55, and other units required to operate the network. The MSC is capable of routing calls and messages to and from the mobile station when the mobile station is making and receiving calls. The MSC also provides a connection to landline trunks when the mobile station is involved in a call. As was indicated above, the cellular network may also be referred to as a Base Station/MSC/Interworking function (BMI) 40.

The mobile station includes a modulator (MOD) 60A, a transmitter 60, a receiver 70, a demodulator (DEMOD) 70A, and a controller 80 that provides signals to and receives signals from the transmitter and receiver, respectively. These signals include signaling information in accordance with the communications standard of the applicable cellular system, and also user speech and/or user generated data. For example, the communications standard can comprise the Global System for Mobile (GSM) communications standard, the Code Division Multiple Access (CDMA) communications standard or any of their progeny and the like. The mobile station may also be configured to meet the wireless application protocol (WAP) specification.

It is understood that the controller 80 includes the circuitry required for implementing the audio and logic functions of the mobile station. By example, the controller may be comprised of a digital signal processor device, a microprocessor device, and various analog to digital converters, digital to analog converters, and other support circuits. The control and signal processing functions of the mobile station are allocated between these devices according to their respective capabilities. The controller thus also includes the functionality to convolutionally encode and interleave message and data prior to modulation and transmission. The controller can additionally include an internal voice coder (VC) 80A, and may include an internal data modem (DM) 80B.

The mobile station 10 also comprises a user interface that includes a conventional earphone or speaker 90, a conventional microphone 100, a display 110, and a user input interface, all of which are coupled to the controller 80. The mobile station also includes a battery 115, such as a vibrating battery pack, for powering the various circuits that are required to operate the mobile station, as well as optionally providing mechanical vibration as a detectable output, as described below. The display can present any of a number of different displays, such as data and menus. The display can also display areas for softkey functions 121A and 121B that can be activated by pressing softkeys 120A and 120B, respectively. The user interface can also include a scroll element to scroll through menu items featured on the display. The scroll element can comprise any of a number of known devices that allow for scrolling through displayed items, including a rolling cylinder, ball or the like. In the illustrated embodiment, however, the scroll element comprises scroll keys 130.

The mobile station 10 also includes a user input interface, which allows the mobile station to receive data. The user input interface can comprise any of a number of devices allowing the mobile station to receive data, such as a keypad 140, a touch display (not shown) or other input device. In embodiments where the user input interface comprises a keypad, the keypad includes the conventional numeric (0-9) and related keys (#, *), and other keys used for operating the mobile station. In addition to the softkeys 120A and 120B, the other keys may include, for example, a SEND key, various menu scrolling keys and a PWR key. Additionally, the keys of the keypad may be illuminated by various methods known to those skilled in the art to produce a visual reminder in response to an event. For one such method of illuminating the keys of the keypad, see U.S. patent application Ser. No. 09/887,127, entitled: Communications Device, filed Jun. 22, 2001 and published as U.S. Publication No. 2002/0019248 A1.

The mobile station 10 can also be provided with an interface (not shown) to allow the audio of the mobile station, including the ring tunes, to be played over an existing audio system. By including the interface, the mobile station can provide a more elaborate speaker and/or ringer system that will allow the mobile station to play polyphonic tunes. Such an interface is described in U.S. Pat. No. 6,163,711 entitled: Method and Apparatus for Interfacing a Mobile Phone with an Existing Audio System issued Dec. 19, 2000 to Juntunen et al.

Mobile station 10 can further include an infrared transceiver 150 or other means of data transfer so that data can be shared with other devices such as other mobile stations, car guidance systems, personal computers, printers and the like. The sharing of data can also be provided according to a number of different techniques. For example, the mobile station may share data via a Radio Frequency Identification (RFID) transponder tag, as such is known to those skilled in the art. Additionally, or alternatively, the mobile station may share data using Bluetooth brand wireless technology developed by the Bluetooth Special Interest Group.

To store data upon receipt from the various sources, the mobile station includes volatile memory 180, such as volatile Random Access Memory (RAM) including a cache area for the temporary storage of data. The mobile station can also include non-volatile memory 160, which can be embedded and/or may be removable such as a removable Subscriber Identification Module (SIM). The non-volatile memory can additionally or alternatively comprise an EEPROM, flash memory or the like, such as that available from the SanDisk Corporation of Sunnyvale, Calif., or Lexar Media Inc. of Fremont, Calif. The memories can store any of a number of pieces of information, and data, used by the mobile station to implement the functions of the mobile station. For example, the memories, and particularly the non-volatile memory, can include a directory or listing of telephone numbers, as well as a name associated with each of the telephone numbers. The memories can also include computer program products that control the operation of all or a portion of the controller 80 to thereby implement the present invention. The controller, which can include embedded cache memory, generates appropriate commands and controls the other component blocks of the mobile station.

In operation, in response to an event, such as an incoming call, a short message, a page or the like, the mobile station 10 receives an event alert, such as a call alert. For example, when the event comprises an incoming call, the base station 30 acts as an intermediary between a device calling the mobile station, such as a landline or mobile telephone, by sending a call alert to the mobile station, to which the controller responds by sending the output control signal to an output reproduction device 210. In response to, and based upon, the output control signal, the output reproduction device generates a detectable output, such as in a human perceptible form including, for example, ring tones or other audible sounds, and/or mechanical vibration, light illumination of all or a portion of the mobile station or other detectable physical indications.

The output reproduction device can include any of a number of known devices within the mobile station, such as a ringer 95, a vibrating battery pack, a light source and/or any other device capable of providing a human perceptible output. Additionally, or alternatively, the output reproduction device can include any of a number of devices located at a distance from the mobile station 10, such as a remote audio system. In this regard, the output control signal can be transmitted from the mobile station via the infrared transceiver 150 or other means of data transfer (e.g., Bluetooth brand wireless technology). And upon reception by the device located at a distance from the mobile station, the output reproduction device responds to the output control signal by generating the detectable output.

It will be appreciated that although as illustrated and described herein the controller 80 sends the output control signal directly to the output reproduction device 210, the mobile station 10 can include an event indicator, such as a call indicator, intermediate the controller and the output reproduction device. In such an instance, the controller sends the output control signal to the event indicator which, in turn, passes the output control signal to the output reproduction device. Further, the event indicator typically includes a sound generator that generates the ring tones according to a predefined sequence in response to an event, such as an incoming call. The sequence of the ring tones is generally generated from the output control signal sent from the controller, which produces the output control signal by reading, from the memory 160, the ring tone or ring tone parameters stored therein. Thus, the output control signal contains the information for the sound generator of the event indicator that defines the ring tone that the sound generator generates for the output reproduction device 210. Hereinafter the detectable output will be described in terms of ring tones provided by the ringer, but it should be understood that the following description can equally apply to other human perceptible outputs, such as other audible sounds, and/or mechanical vibration, light illumination of all or a portion of the mobile station or other detectable physical indications without departing from the spirit and scope of the present invention. It should also be understood that, as used herein, the term ring tones includes any one of a number of different types of audible outputs, including monotone or polyphonic ring tones, ring tunes or the like. In this regard, as used by those skilled in the art, the terms ring tones and ring tunes may be used interchangeably.

When the event comprises an incoming call, the call alert can include caller identification information about the device calling the mobile station 10 and/or the caller operating the calling device. The call alert can include any of a number of different known caller identification information that includes an identification number and/or name associated with the calling device or caller operating the calling device, as such is known. For example, the caller identification information can comprise Automatic Number Identification (ANI), Caller ID, Caller Line Identification (CLI) and/or Calling Name Identification (CNAM). Thus, upon receipt of the call alert, in addition to activating the event indicator, the controller 80 can also display the caller identification information, as described below, on the display 110.

As is known to those skilled in the art, all or a portions of caller identification information can be blocked or may otherwise be unavailable. Thus, if the base station 30 only forwards an identification number to the mobile station, as opposed to both the identification number and name, a name associated with the identification number can thereafter be determined locally by the mobile station. In this regard, the mobile station 10 can have stored in memory, such as non-volatile memory 160, selected identification numbers and associated names, such as in an electronic directory. Thus, upon receipt of the identification number in the call alert, the controller can determine a name associated with the identification number by querying the memory within which the identification numbers and names are stored. Also, even if the base station forwards the identification number and an associated name, the controller can replace the name received with a name associated with the identification number stored in memory. As such, the mobile station can define names for select identification numbers differently than the names otherwise transmitted with the identification numbers.

As stated, in response to an event, the event indicator 200 generates a sequence of ring tones. In some instances, however, it is desirable to program the ring tones so that a user of the mobile station 10 can identify events on the user's mobile station as opposed to mobile stations nearby, and/or so that the user is provided with information relating to events on the user's mobile station. In this regard, the user may desire to program the ring tone so that the ring tone spells out a text output, such as a text message or a name associated with an incoming call, in a predefined mnemonic code. By so programming the ring tone, the user can identify events, such as incoming calls, on the user's mobile station as well as distinguish events on the user's mobile station from those on other mobile stations nearby. As such, the mobile station includes a code generator 220 that is capable of converting at least one character of the desired text output into a coded representation of the character(s) according to a predetermined mnemonic code. In this regard, the mobile station can generate the ring tone based upon the coded representation of the character(s).

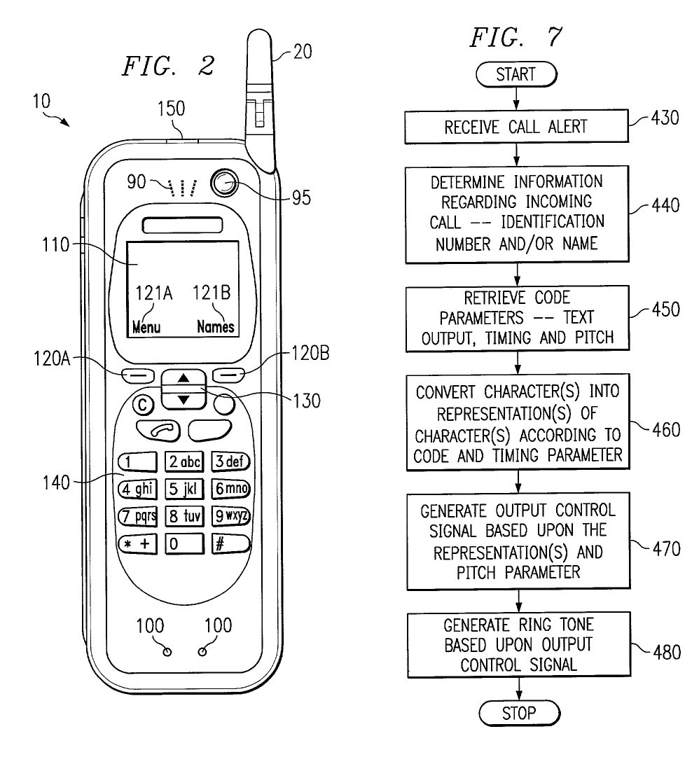

The code generator 220 can convert the character(s) according to any one of a number of mnemonic codes but, in a preferred embodiment, the code generator converts the character(s) according to the Morse Code. In this regard, FIG. 3 illustrates various international characters and the Morse Code associated with each character. Whereas the illustrated Morse Code character set represents the character set for the English language, the character set can alternatively be configured to for any and all languages and character sets, including all European languages, the Latin alphabet, Esperanto, Japanese, Korean, Arabic, Hebrew, Russian and Greek.

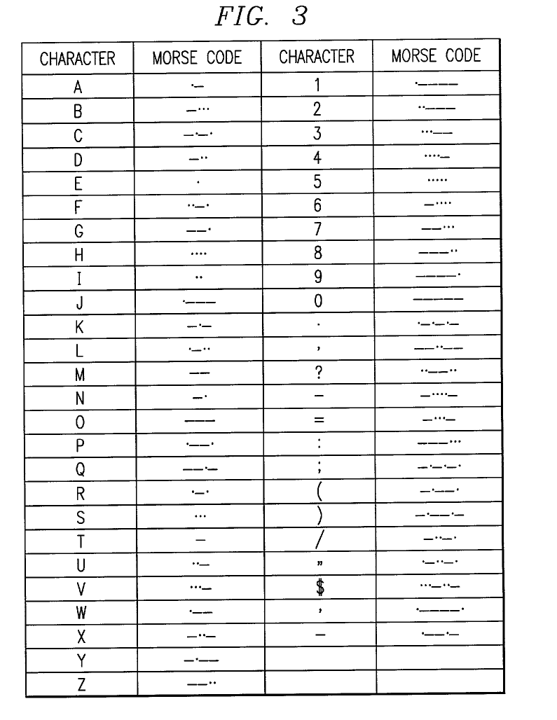

As shown in FIG. 3, and known to those skilled in the art, Morse Code represents characters and symbols as a series of dots and dashes. Referring to the timing diagram of FIG. 4A with respect to the word PARIS, according to one method of Morse Code timing, each dot represents one count of time, and each dash represents three counts of time. Also, intra-character spacing (the spacing in between each dot and dash within each character) is defined to equal one count of time, while inter-character spacing (the spacing in between each character) is defined to equal three counts of time, and inter-word spacing (the spacing in between words) is defined to equal seven counts of time. As shown in FIG. 4A, coding the word PARIS requires 50 counts of time. Taking the word PARIS to be the standard length for Morse Code speed (i.e., 50 counts per word), then, the time required per count can be determined based upon a given words-per-minute rate (wpm). For example, 5 wpm equals 250 counts per minute (i.e., 5 wpm×50 counts per word) which, in turn equals one count every 240 milliseconds (i.e., [250 counts per minute×one minute/60 seconds]⁻¹). In this regard, 13 wpm would translate into approximately one count every 92.3 milliseconds. This method of sending code is sometimes referred to as standard timing.

Referring to FIG. 4B, an alternative to standard timing is the Farnsworth method of Morse Code timing. According to the Farnsworth method, the dots and dashes, as well as the intra-character spacings, are sent at a higher speed than that in standard timing. And in turn, the inter-character spacings and inter-word spacings are increased accordingly to achieve the desired words per minute. Thus, for example, to transmit at an overall rate of 5 wpm with a character transmission rate of 13 wpm according to the Farnsworth method, the dots and intra-character spacings would take approximately 92.3 milliseconds, and the dashes would take approximately 276.9 milliseconds (i.e., 3×92.3 milliseconds). In turn, to achieve an overall transmission rate of 5 wpm, the inter-character spacings would take 1.443 seconds, while the inter-word spacings would take 3.367 seconds.

The code generator 220 can comprise any of a number of different elements, and can be located in any one of a number of different locations but, in one advantageous embodiment illustrated in FIG. 1A, the code generator is embodied in a computer program product stored by the controller 80 or a related memory device, such as the non-volatile memory 160. In an alternative embodiment, a portion of which is shown in FIG. 11B, the mobile station 10 can be included in a mobile communications system that includes the code generator. According to this system, the mobile services switching center MSC can be connected to a server GTW 225 (Gateway), which is in connection with a wide area network (WAN) 227, such as the Internet. The code generator, in turn, can also be in connection with the WAN. In this regard, the code generator can be located remote from the mobile station and stored by a processing element, such as a personal computer or other high level processor, or a memory device related with the same. By directly or indirectly connecting both the mobile station and the code generator to the WAN, the code generator can be in communication with the mobile station, such as according to the WAP specification, to thereby carry out the functions of the code generator as it relates to the mobile station.

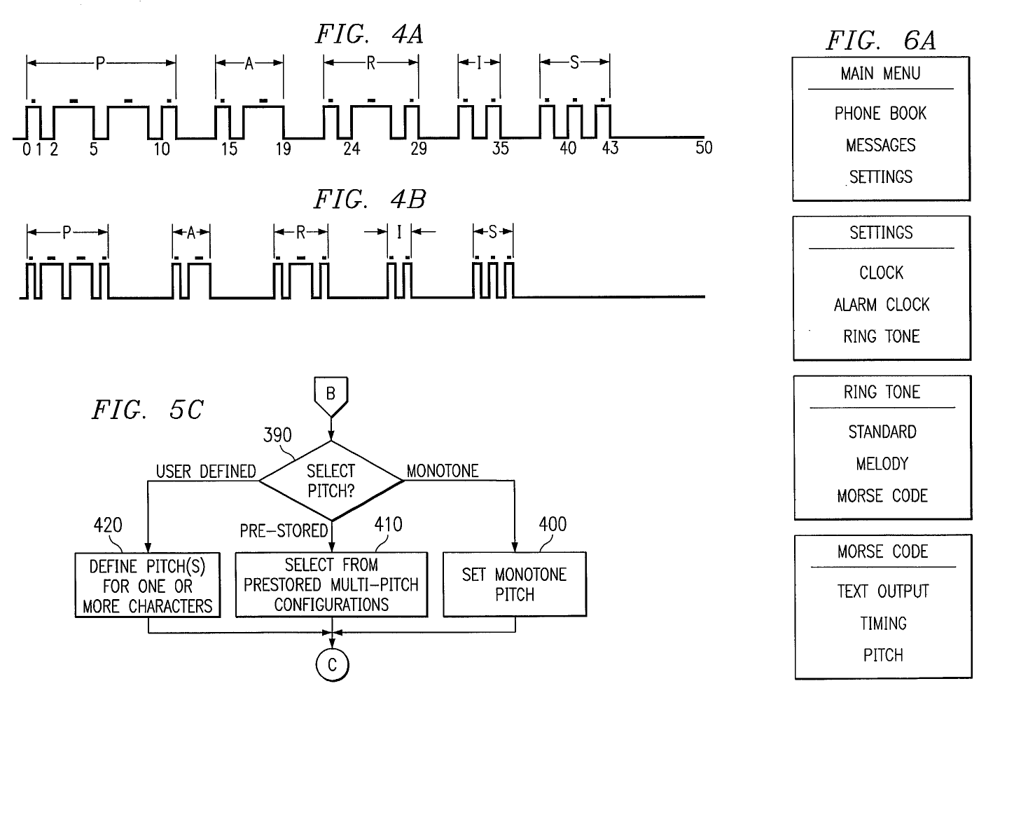

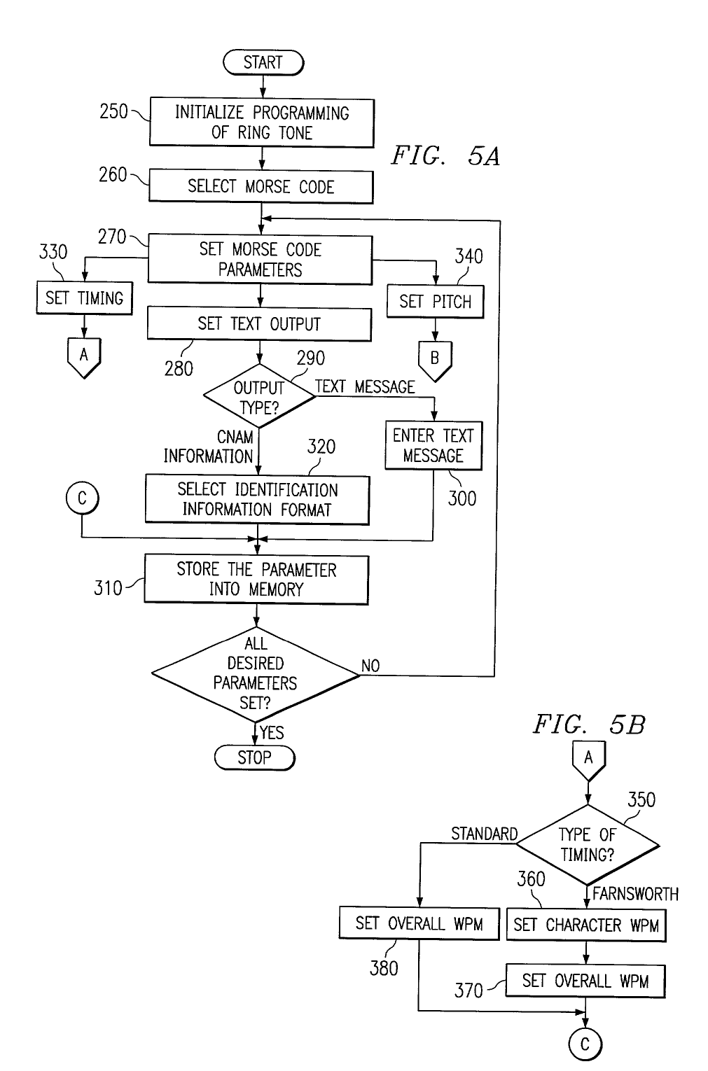

As shown in FIGS. 5 and 6, a method of programming the ring tone of a mobile station begins by initializing the programming of the ring tone. Initialization can be accomplished in any one of a number of manners but, in one embodiment, is accomplished by selecting an option to program the ring tone and thereafter selecting Morse Code as the ring type, as shown in blocks 250 and 260 of FIG. 5A and FIG. 6A. It should be understood that the displays illustrated in FIG. 6 can be implemented in a mobile station with a larger display or, equally, can be implemented on a display of the size of an ordinary mobile station, e.g., on a matrix-type liquid crystal display. After selecting Morse Code, the user is presented with a series of code parameters to thereby define the ring tone, as illustrated in block 270 of FIG. 5A. As shown in FIG. 6B and block 280 of FIG. 5A, by selecting text output, the user has the option to enter a text message or select caller identification information (e.g., an identification number and/or name associated with an incoming call) as the character(s) to convert into coded representations for the ring tone, as shown in block 290.

If the user selects to enter a text message, the display 110 then presents the user with a screen whereby at least one character can be entered and displayed on the display, such as by means of a cursor moved by scroll keys 130, as illustrated by FIG. 6B and block 300 of FIG. 5A. The mobile station 10 can receive the characters of the text message in any one of a number of different manners but, according to one embodiment, the characters are received via the keypad 140 on the user interface of the mobile station, where the keypad comprises twelve keys (keys 0-9, * and #). In this regard, each character can be produced depressing a specific key one or more times, or by depressing combination of two or more keys one or more times. As such, the pressing of one or more keys may correspond to a specific character, which can be displayed on the mobile station's display. Additionally, or alternatively, a tone having a predetermined pitch can be reproduced in response to the pressing of the key(s), through the speaker 90 of the mobile station. Additionally, or alternatively, the character(s) can be received via the softkeys 120A and 220B, and/or the scroll keys 130 by selecting the characters from a menu. The character(s) can also be received via the infrared transceiver 150 or other means of local data transfer. Additionally, or alternatively, the character(s) can be generated by voice recognition routines stored in memory in response to an audible input via the microphone 100, as such is known.

As shown in block 310 of FIG. 5A, after all of the characters of the text message have been received, the controller 80 can save the text message into memory, such as into non-volatile memory 160, so that the text message can be subsequently converted into the coded representation for presentation in response to an event, as described below. Although conversion of the text message into its coded representation can be performed in response to an event, the code generator 220 can convert the text message into the coded representation of the text message without awaiting notification of an event. And upon converting the text message, the controller can save the coded representation into memory. In this embodiment, the coded representation can also be displayed upon the display either as the code generator converts each character, or after the code generator has converted all of the characters.

If the user selects the text output to comprise caller identification information, such as an identification number and/or name associated with an incoming call, the user can then select the format of the identification information as the text output, as shown in block 320 of FIG. 5A. In this regard, the user can format the text output to comprise the identification number and/or name associated with an incoming call. Further, if the user selects to format the text output to include the name associated with the incoming call, if so received, the user may be presented with further options to format the text output to include the entire name forwarded to the mobile station or a portion of the name, such as only a last name or a first name. If the name received is otherwise associated with a telephone or other identification number that is locally stored in memory, the controller can utilize the name that is associated with the telephone or other identification number instead of the name received, particularly if the locally stored name is the name by which the user of the mobile station references the caller associated with the telephone or other identification number, such as the caller's nickname. Following selecting the format of the identification information, the selection of identification information as the text output, as well as the format of the name information, can be saved into memory, such as into non-volatile memory 160, as shown in block 310.

It will be appreciated that for some identification numbers, a name will not be received with the identification number nor will the mobile station include a locally stored name associated with the telephone or other identification numbers forwarded to the mobile station 10 from the base station 30 in response to various incoming calls. As such, the mobile station can have a default text message associated with such identification numbers. For example, the mobile station can associate a default text message such as, “Incoming Call,” or the identification number itself, to those identification numbers for which the mobile station cannot otherwise determine a name.

Either before or after defining the text output, the user can optionally set other parameters with respect to the ring tone, such as the timing of the Morse Code characters and the pitch of the Morse Code tones, as illustrated in blocks 330 and 340, respectively, of FIG. 5A. As shown in block 350 of FIG. 5B and FIG. 6C with respect to the timing of the Morse Code characters, the user can select whether to output the coded representations in Farnsworth timing or standard timing. As described above, according to the Farnsworth timing method, the transmission of each word has a selected wpm (words-per-minute) but, to speed up transmission of the individual characters, the Morse Code characters are transmitted at a different, higher wpm. In contrast, in standard timing, the user only selects a words per minute for the overall message. Thus, if the user selects Farnsworth timing, the user thereafter defines a wpm for both the overall text output and the individual characters of the text output, as shown in blocks 360 and 370. If the user selects standard timing, however, the user only defines a wpm for the overall text output, as illustrated in block 380. Whichever timing the user defines for the text output, after selecting the timing method and respective wpm's, the method of timing as well as the respective wpm definitions are saved into memory, such as non-volatile memory 160, as illustrated in block 310 of FIG. 5A.

As to the pitch, whereas codes such as Morse Code are traditionally monotone codes, the mobile station 10 can output Morse Code with each character or some of the characters having one or more different pitches. In this regard, as shown in block 390 of FIG. 5C, the pitch of the characters of the text output can be defined to have, for example, a monotone pitch or one of a series of pre-stored configurations in which different pitches are pre-assigned to respective characters. Alternatively, one or more pitches of one or more characters can be defined by the user. If the user selects a monotone pitch, the coded representation of each character will be output by the sound generator as a series of monotone tones. The pitch(es) of the tones, however, can be selected by the user, such as by scrolling through a series of pitches using the scroll keys 130, as illustrated in block 400 of FIG. 5C. As shown in block 410, if the user selects a pre-stored configuration, the user can be presented with one or more configurations where each character is associated with at least one different pitch. For example, one or more characters can be associated with a series of one or more pitches, with the pitches of each character either ascending or descending. Whereas the mobile station can support a plurality of configurations, the mobile station will typically only include one configuration with each character associated with a unique pitch.

If the user selects to define the pitch of one or more characters, the pitch of the characters can be individually set by the user, such as scrolling through a series of pitches using scroll keys 130, as shown in block 420 of FIG. 5C. To ease the process of defining the pitches for the characters, and to provide a pitch for characters not so defined, each character can initially be associated with one or more default pitches, such as from one of the pre-stored configurations. Then, as the user selects a character to thereby define the pitch(es) for that character, the user can scroll through a series of pitches higher and lower than the default pitch, such as via the scroll keys. In such an embodiment, the default pitch will continue to be associated with those characters for which the user does not define a pitch. However, after the user defines the pitch for the characters, the pitch for each character is saved into memory, such as non-volatile memory 160, as illustrated in block 310 of FIG. 5A.

After the code parameters have been defined, the ring tone can be generated by the mobile station 10 in response to events based upon the parameters previously set and stored in memory. Thus, the present invention provides a method for generating a detectable output, e.g., ring tone, from a mobile station. The method will be described in terms of an incoming call, but it should be understood that the event can comprise any of a number of different events, such as notification of a new message, triggering of a timed alarm, etc. As an overview, when a calling device, such as a mobile or landline telephone, desires to call the mobile station, the base station 30 acts as an intermediary by sending a call alert to the mobile station via at least one RF channel to thereby alert the mobile station of the attempted call. After alerting the mobile station, the base station waits for a fixed time period, which defines a ringing cycle, to receive a response from the mobile station. The response indicates the mobile station is ready to accept the call.

If the mobile station 10 does not respond within the ringing cycle time period, the base station 30 releases the call by terminating the call alert to the mobile station and signaling to the caller that the mobile station is unavailable. During the ringing cycle, the mobile station generates the ring tone to alert the user of the mobile station of the incoming call, as described below. When a user answers the call or interrupts the call, such as via the user interface, the user interface gives a signal to the controller 80 which, in turn halts the output control signal to thereby stop the ring tone. If the user decides to answer the incoming call, however, a response is sent from the mobile station to the base station indicating that the call is to be accepted. The base station then sets up a connection on the existing RF channel or establishes a second RF channel where the call will ultimately be connected such that the calling device and mobile station can thereafter communicate with one another.

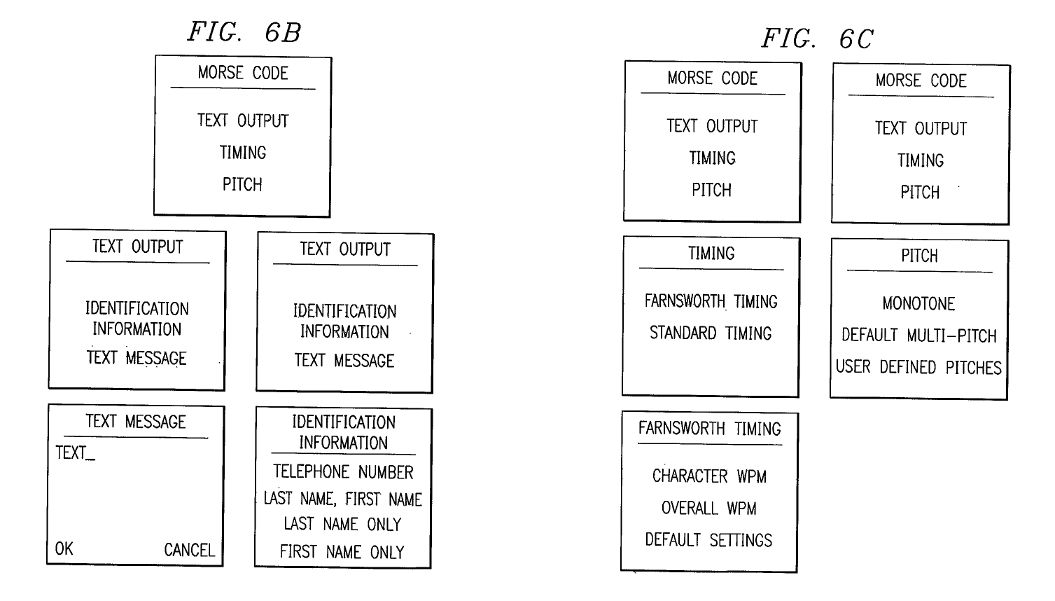

As stated, when a calling device desires to call the mobile station 10, the base station 30 sends a call alert to the mobile station. Therefore, referring now to FIG. 7, the method of generating the ring tone generally begins with receiving the call alert, as shown in block 430. As described above, the call alert can include information regarding the incoming call, such as the identification number and/or name associated with the calling device and/or caller. However, a name may be unavailable for some incoming calls. Thus, as shown in block 440, from the call alert and/or internal memory, the controller can determine information regarding the incoming call, including the identification number and/or name. It should be understood, though, that the mobile station need not receive any information regarding the incoming call. In this regard, the mobile station can generate a ring tone based upon a text message that is independent of the incoming call, as described below, without any information regarding the incoming call.

After the mobile station 10 determines the information regarding the incoming call, or after the mobile station receives the call alert for embodiments where the mobile station does not receive any information regarding the incoming call, the controller 80 generates an output control signal. The output control signal may include or be associated with code parameters, if necessary. To generate the output control signal when Morse Code is selected as the ring type, for example, the controller first retrieves the code parameters from memory, including the text output, the timing and the pitch, as shown in block 450. And with the code parameters, as illustrated in block 460, the code generator 220 converts the character(s) of the text output into coded representations of the character(s) according to the timing parameter. If the text output comprises a text message, the code generator merely converts the text message as saved into a coded representation. If the text output comprises identification information, however, the code generator converts the information regarding the incoming call according to the format previously defined. But if the controller failed to determine information regarding the incoming call, the code generator can convert the default message stored in memory, as described above. It will be appreciated that, as stated above, in an alternative embodiment, the code generator can convert the character(s) of a predefined text message or default message before the character(s) are saved. In such an embodiment, the coded representation(s) of the characters will be saved in memory and, thus, the code generator will not need to again convert the character(s) after retrieving the code parameters.

After obtaining the coded representation(s) of the character(s), the controller 80 can generate the output control signal based upon the coded representations and the respective pitch of each character as defined by the pitch parameter, as shown in block 470. Thereafter, once the controller has generated the output control signal, the ring tone can be generated based upon the output control signal, as illustrated in block 480. In this regard, the controller sends the output control signal to the output reproduction device 210. Based upon the output control signal, the output reproduction device, such as the ringer 95, audibly reproduces the coded representations of the character(s) according to the timing and pitch parameters to thereby alert the user of the mobile station to the incoming call.

Therefore, the system, mobile station and method of the present invention allow a user of a mobile station to uniquely associate any number of events with different ring tones without being constrained to a small number of pre-stored ring tones. Further, the ring tone of the system, mobile station and method of the present invention is capable of spelling out a text message in a predefined code so that the ring tone is not only associated with a respective event, but also identifies the respective event. In this regard, the system, mobile station and method of the present invention can alternatively determine information regarding an incoming call to the mobile station and thereafter spell out a name associated with the incoming call in the predefined code. By spelling out a text message or name associated with the incoming call, not only can the ring tone identify an event, but the ring tone can additionally distinguish a ring tone between two users in the same space having the same type of mobile phone.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A communications system comprising:
a communications network comprising at least one terminal for communication, wherein each terminal includes a transmitter and a receiver for transmitting and receiving speech, respectively;
at least one output reproduction device capable of generating a detectable output in response to an event, wherein the detectable output is generated based upon a coded representation of at least one character; and
a code generator in communication with the communications network including the at least one terminal, wherein said code generator is capable of receiving at least one character and thereafter converting the at least one character into the coded representation of the at least one character according to a predetermined mnemonic code.

2. A communications system according to claim 1, wherein each terminal further includes a user interface capable of receiving the at least one character.

3. A communications system according to claim 1, wherein said code generator is located remote from the at least one terminal, and wherein the transmitter of each terminal is capable of transmitting the at least one character to said code generator.

4. A communications system according to claim 3, wherein said code generator is in communication with the communications network according to the wireless application protocol (WAP) standard.

5. A communications system according to claim 1, wherein said at least one output reproduction device is capable of generating detectable output in human perceptible form.

6. A communications system according to claim 1, wherein said code generator is capable of converting the at least one character into the coded representation of the at least one character according to Morse Code.

7. A communications system according to claim 1, wherein said at least one output reproduction device is capable of generating audible sounds based upon the coded representation of the at least one character with the audible sounds associated with the coded representation of each character having at least one different predetermined pitch.

8. A communications system according to claim 1, wherein each terminal further includes a controller in communication with said at least one output reproduction device and said code generator, wherein the event includes an incoming call to the at least one terminal, and wherein said controller of each terminal is capable of determining information regarding the incoming call which comprises the at least one character.

9. A communications system according to claim 1, wherein the at least one terminal includes said at least one output reproduction device.

10. A terminal adapted to communicate via a communications system, wherein the terminal includes:
a transmitter and a receiver for transmitting and receiving speech, respectively;
a code generator capable of receiving at least one character and thereafter converting the at least one character into a coded representation of the at least one character according to a predetermined mnemonic code; and
an output reproduction device capable of generating a detectable output in response to an event, wherein the detectable output is generated based upon the coded representation of at least one character.

11. A terminal according to claim 10 further comprising a user interface capable of receiving the at least one character.

12. A terminal according to claim 10, wherein said output reproduction device is capable of generating a detectable output in human perceptible form.

13. A terminal according to claim 10, wherein said code generator is capable of converting the at least one character into the coded representation of the at least one character according to Morse Code.

14. A terminal according to claim 10, wherein said output reproduction device is capable of generating audible sounds based upon the coded representation of the at least one character with the audible sounds associated with the coded representation of each character having at least one different predetermined pitch.

15. A terminal according to claim 10 further comprising a controller in communication with said output reproduction device and said code generator, wherein the event includes an incoming call to the terminal, wherein said controller is capable of determining information regarding the incoming call which comprises the at least one character.

16. A method of generating a detectable output from a terminal adapted to transmit and receive speech to thereby communicate via a communications system, said method comprising:
obtaining a text output including at least one character;
converting the at least one character of the text output into a coded representation of the at least one character according to a predetermined mnemonic code; and
generating the detectable output in response to a predefined event based upon the coded representation of at least one character.

17. A method according to claim 16, wherein generating the detectable output comprises generating the detectable output in human perceptible form.

18. A method according to claim 16, wherein converting the at least one character comprises converting the at least one character into the coded representation of the at least one character according to Morse Code.

19. A method according to claim 16 further comprising providing a detectable output parameter defining a pitch associated with the coded representation of at least some of the characters.

20. A terminal adapted to communicate via a communications system, wherein the terminal includes:
a transmitter and a receiver for transmitting and receiving speech, respectively;
a controller responsive to the receiver for determining information regarding an incoming call that is comprised of at least one character;
a code generator responsive to said controller for receiving the at least one character and thereafter converting the at least one character into a coded representation of the at least one character according to a predetermined mnemonic code; and
an output reproduction device capable of generating a detectable output in response to receipt of the incoming call based upon the coded representation of the at least one character.

21. A terminal according to claim 20, wherein said output reproduction device is capable of generating a detectable output in a human perceptible form.

22. A terminal according to claim 20, wherein said code generator is capable of converting the at least one character into the coded representation of the at least one character according to Morse Code.

23. A terminal according to claim 20, wherein said output reproduction device is capable of generating audible sounds based upon the coded representation of the at least one character with the audible sounds associated with the coded representation of each character having at least one different predetermined pitch.

24. A method of generating a detectable output from a terminal adapted to transmit and receive speech to thereby communicate via a communications system, said method comprising:
receiving an incoming call to the terminal and thereafter determining information regarding the incoming call that is comprised of at least one character;
converting the at least one character into a coded representation of the at least one character according to a predetermined mnemonic code; and
generating a detectable output in response to receipt of the incoming call based upon the coded representation of at least one character.

25. A method according to claim 24, wherein generating the detectable output comprises generating the detectable output in a human perceptible form, wherein selecting a type of detectable output occurs before receiving the incoming call.

26. A method according to claim 24 further comprising providing a detectable output parameter defining a pitch associated with the coded representation of at least some of the characters.

27. A method according to claim 24, wherein converting the at least one character comprises converting the at least one character such that the coded representation of each character is associated with a different predetermined pitch.
